(19) United States
(12) Patent Application Publication
(10) Pub. No.: US 2017/0227080 A1
(43) Pub. Date: Aug. 10, 2017

(54) TORSIONAL DAMPING DEVICE

(71) Applicant: Cermak Peterka Peterson, Inc., Fort Collins, CO (US)

(72) Inventor: Kurt R. Strobel, Fort Collins, CO (US)

(21) Appl. No.: 15/015,962

(22) Filed: Feb. 4, 2016

(51) Int. Cl. F16F 7/104

(52) U.S. Cl. CPC F16F 7/104; F16F 2226/04

(57) ABSTRACT

A torsional damping device and methods are disclosed. The device has an inertial body, a housing, a biasing mechanism, and a damping element. The housing has a mounting surface for mounting to a structure experiencing a rotational force, the inertial body rotatably and removably coupled to the housing. The biasing mechanism is configured to bias the inertial body towards the neutral position. The damping element is configured to damp motion of the inertial body relative to the housing. The second position of the inertial body comprises a position wherein the inertial body is at least one of (a) in motion relative to the housing and (b) experiencing a net rotational force from at least one of (a) the biasing mechanism and (b) the damping element. The inertial body is configured to effectuate a counter-rotational force on the structure when the inertial body is in the second position.

### BACKGROUND

Field

The present invention relates generally to stabilizing devices, and more specifically to stabilizing a structure exposed to wind.

Background

FIG. 1 illustrates a typical solar farm 10 which has a number of solar panel systems 100 installed therein. In the illustrated case, each solar panel system 100 is what is known in the industry as a single axis tracker system, meaning it is configured to rotate about a longitudinal axis X, which may include a horizontal shaft 104. The horizontal shaft 104 is configured to receive a solar panel 102, and control the rotational position of the solar panel 102 to track the sun. The horizontal shaft 104 is generally affixed to the ground or a substrate by way of a structural mount 106, which may be a vertical rod configured to rotatingly receive the horizontal shaft 104.

FIG. 2 illustrates another view of a typical solar panel system 100, and in particular a control system 108 for controlling the rotational position of the panel mount 104. Of note, the horizontal shaft 104 may have an exposed end 110, which will be referenced in subsequent portions of this document.

FIG. 3 illustrates a side view of a solar farm 10, and in particular how wind moves across the solar panel systems 100. As can be appreciated, as wind moves across the solar panels 102, it repeatedly separates and reconvenes between systems 100 in a phenomenon known as vortex shedding, thereby inducing significant stress on the horizontal shaft 104, structural mount 106, and/or other mounting components. When winds move across the solar farm 10 in a particular manner, the winds may initiate vibration or movement of the solar panel systems 100 that is at or near a resonant frequency of the respective systems 100, resulting in extreme movement or galloping of the systems 100.

This resonant motion, and particularly galloping, results in potentially unreliable equipment, such as premature failure at high stress points.

Moreover, when engineers attempt to design solar systems in a manner that mitigates the effects of the resonance and/or galloping described above, they may over-design new systems.

In some cases, a solar farm 10 designed for a location with a particular weather pattern may become damaged or obsolete if the weather pattern changes to one not previously accounted for. For example, in previously-installed solar farms, operators may be faced with detrimental operating and/or repair costs should the location of a solar farm experience winds that are stronger or different than those anticipated. These operators have little ability to, for example, retrofit a wind farm with equipment suitable for higher winds once the initial installation is complete.

There therefore remains a need in the industry for a means for reducing the stresses caused by the wind on various components in a solar panel system, upgrading components in a wind farm to withstand higher winds, and/or other new and innovative features.

### SUMMARY

Embodiments disclosed herein address the above stated needs by providing a torsional damping device or method described herein.

In one example, a torsional damping device has a first inertial body, a housing, a biasing mechanism, and a damping element. The first inertial body has a rotational axis and a moment of inertia relative to the rotational axis, the first inertial body rotatable about the rotational axis between a neutral position and a second position. The housing is configured to house the inertial body, and has a mounting surface for mounting to a structure experiencing a rotational force, the first inertial body rotatably and removably coupled to the housing. The biasing mechanism is configured to bias the first inertial body towards the neutral position. The damping element is configured to damp motion of the first inertial body relative to the housing. The neutral position of the first inertial body is a position wherein the first inertial body is not in motion relative to the housing and is not experiencing a net rotational force. The second position of the first inertial body is a position wherein the first inertial body is at least one of (a) in motion relative to the housing and (b) experiencing a net rotational force from at least one of (a) the biasing mechanism and (b) the damping element. The first inertial body is configured to effectuate a counter-rotational force on the structure when the first inertial body is in the second position.

In another example, a method of damping wind effects on a solar panel system is provided. The method includes providing a torsional damping device, affixing the torsional damping device to a mounting shaft of the solar panel system; subjecting the solar panel system to wind tending to cause the solar panel system to oscillate; and allowing a first inertial body to rotate relative to a housing in the device.

In another example, a method of retrofitting a solar panel system is provided. The method includes providing a torsional damping device, and affixing the torsional damping device to a mounting shaft of the solar panel system.

### BRIEF DESCRIPTION OF THE DRAWINGS

FIG. 1 is a perspective view of a typical solar farm;

FIG. 2 is a rear perspective view of a typical solar panel system;

FIG. 3 is a side view of a solar farm;

FIG. 4 is an exploded perspective view of a torsional damping device;

FIG. 5 is a top view of some components of the device in FIG. 4;

FIG. 6 is a side section view of the device in FIG. 4;

FIG. 7 is an exploded perspective view of another torsional damping device;

FIG. 8 is a top view of some components of the device in FIG. 7;

FIG. 9 is a side section view of the device in FIG. 7;

FIG. 10 is an exploded perspective view of another torsional damping device;

FIG. 11 is an exploded perspective view of yet another torsional damping device;

FIGS. 12A-12C illustrate various aspects of a relationship between an inertial body and a mounting feature;

FIG. 13 is an end section view of a biasing mechanism;

FIG. 14 is a flowchart of a method; and

FIG. 15 is a flowchart of another method.

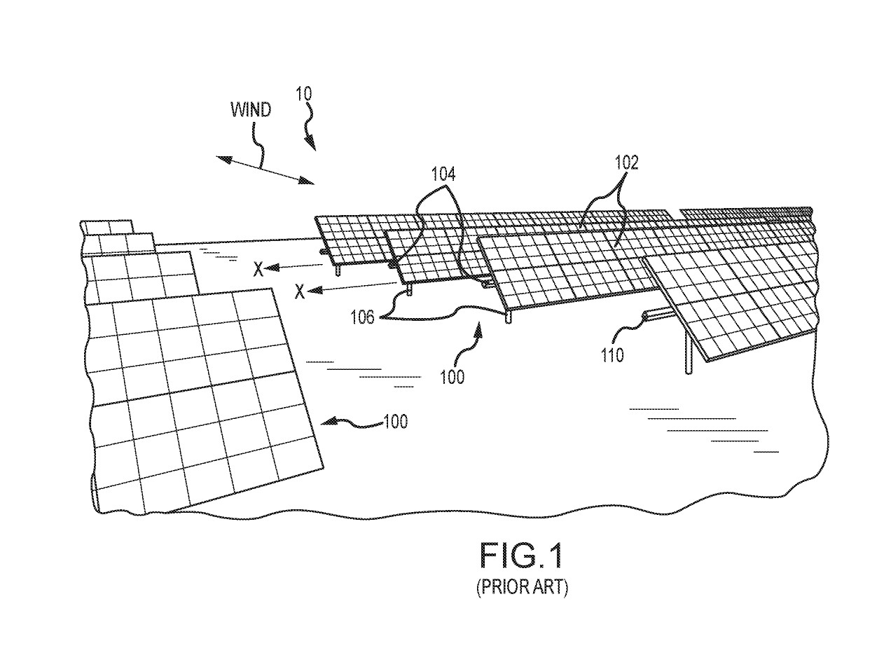

### DETAILED DESCRIPTION

Before providing a detailed description of various embodiments described herein, it is noted that all absolute terms, particularly those describing relative features such as “round”, “horizontal”, etc., are to be understood as meaning within a reasonable manufacturing or industry tolerance. The word “exemplary” is used herein to mean “serving as an example, instance, or illustration.” Any embodiment described herein as “exemplary” is not necessarily to be construed as preferred or advantageous over other embodiments. Claims reciting “at least one of A and B” shall be construed to recite “A and/or B”. Likewise, where the description recites “A and/or B”, support should be found for claim language reciting “at least one of A and B.”

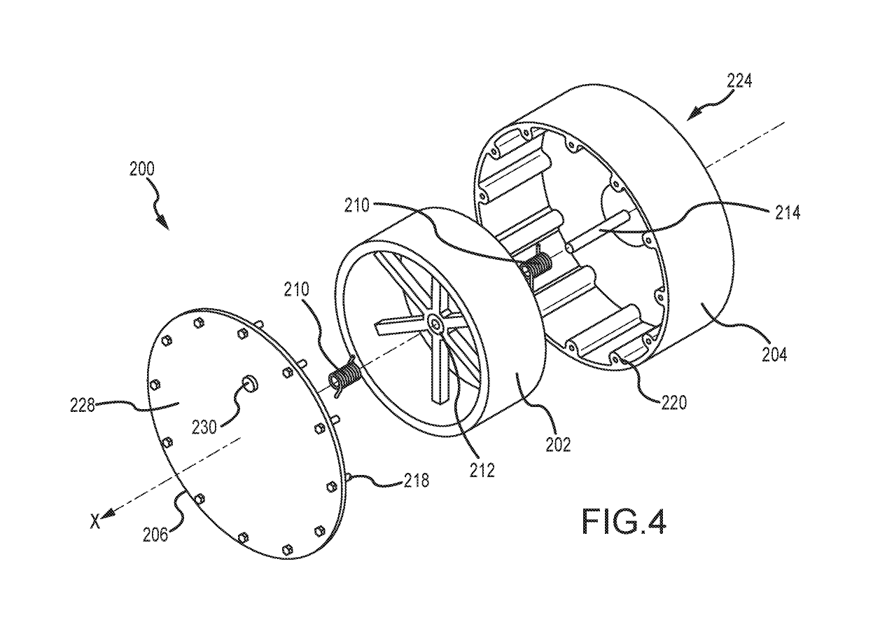

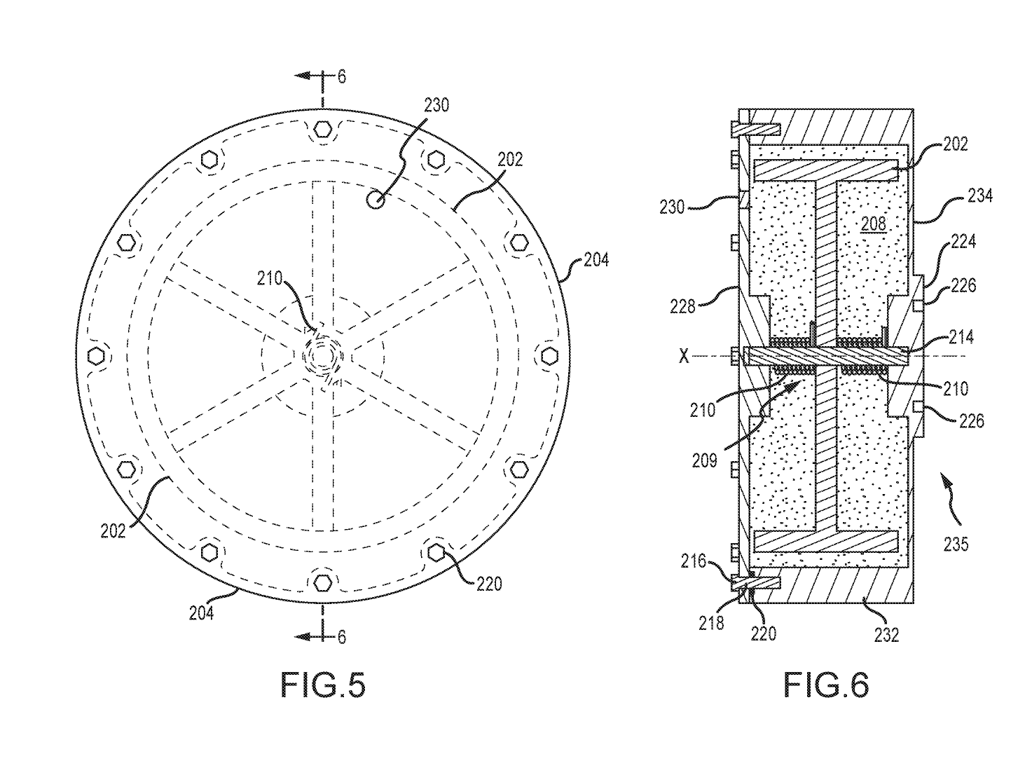

Turning now to FIGS. 4-6, broadly stated, some embodiments described herein provide a torsional damping device 200, or device 200. The device 200 may have an inertial body 202 housed in a housing 204, which may have a cover 206. A viscous fluid 208 may fill voids between the inertial body 202 and the housing 204. A biasing mechanism 210 such as one or more springs or torsional springs may be provided to bias the inertial body 202 towards a neutral position. Combined, the biasing mechanism 210 and the viscous fluid 208 may provide a damping element 209. The inertial body 202 may have a bearing 21 whereby the inertial body 202 is mounted to and rotatable about an axle 214 in the housing.

In some embodiments, the device has a detachable cover 206. As illustrated in FIG. 6, the detachable cover 206 may include a fastening mechanism 216, which may include a fastener 218, a fastener receiver 220, and a sealing element 222. For example, one or more screws may be provided to enable an operator or manufacturer to affix the detachable cover 206 to another body 232 of the housing 204, while a sealing element 222 such as a seal may prevent the viscous fluid 208 from leaking from the device 200.

Although not illustrated, those skilled in the art will understand that the detachable cover 206 may be detachable using any means now known or as yet to be developed, including, without limitation, a hinge mechanism, a cam mechanism, and/or a screw mechanism. In some embodiments, the cover is not detachable, and instead may be unitary with the body 232.

Returning to FIG. 4, the inertial body 202 has an inherent moment of inertia relative to a longitudinal axis X. The moment of inertia may be uniform along a longitudinal length of the inertial body 202; that is, the inertial body 202 may be substantially cylindrical in shape, with, for example, a majority of the mass of the inertial body 202 at a region distal from the longitudinal axis X, although those skilled in the art will understand that this feature is not necessary for a functioning device 200. Those skilled in the art will understand, however, that the inertial body 202 need not be substantially cylindrical in shape; that is, any object with a suitable moment of inertia may be employed as the inertial body 202. The inertial body 202 may be made of a relatively dense material such as a carbon or stainless steel or other dense materials now known or as-yet to be developed. In some embodiments, the inertial body 202 may be coated with a second material to reduce or eliminate corrosion. In some embodiments, the viscous fluid 208 may comprise a fluid to reduce or eliminate corrosion of any components in contact with the viscous fluid 208.

Continuing with FIGS. 4-6, the biasing mechanism 210 may be a torsional spring to bias the inertial body 202 towards a stationary position relative to the housing 204. For example, the biasing mechanism 210 may provide a plurality of springs configured to apply torsional forces on the inertial body 202 if the inertial body 202 is rotated out of a neutral position relative to the housing 204.

When the device 200 is mounted to a structure such as a horizontal shaft 104 in a solar panel system 100, torsional motion of the solar panel system 100 will tend to cause the inertial body 202 to rotate relative to the housing 204. The biasing mechanism 210 may be selected so as to bias the inertial body 202 towards a first position that is fixed relative to the housing 204. That is, the biasing mechanism 210 may bias the inertial body 202 towards a particular degree of rotation wherein the inertial body 202 does not experience a net rotational force in either direction relative to the housing 204. Relatedly, the viscous fluid 208 may be selected so as to bias the inertial body 202 towards a position that is fixed relative to the housing 204. That is, the viscous fluid 208 may tend to bias the inertial body 202 to come to a stop if the inertial body 202 is rotating relative to the housing 204.

Together, the inertial body 202, the viscous fluid 208, and the biasing mechanism 210 may be configured to dampen motion of a structure such as a solar panel system 100 that is moving, such as galloping at or near a resonant frequency of the solar panel system. In some embodiments, the inertial body 202 and the biasing mechanism 210 may be selected to create a natural frequency of rotational vibration that matches or nearly matches a rotational vibration frequency of the solar panel system 100.

In some embodiments, the torsional damping device 200 is configured to be field-installable and/or adjustable.

For example, a detachable cover 206 may allow an operator to transport the device 200 in an unassembled state, and then assemble the device 200 to a shaft 104 in the field. A port 230 in the housing 204, such as the cover 206 and/or the body 232, may allow an operator to fill the housing 204 with the viscous fluid 208 before or after assembly to the shaft 104.

In some embodiments, the device 200 is adjustable. In some adjustable embodiments, the housing 204 may be configured or sized to accept different sizes or styles of inertial bodies 202 and/or biasing mechanisms 210. The operator may, for example, wish to remove a first inertial body 202 having a first moment of inertia and replace it with a second inertial body 202 having a moment of inertia that is different from the first inertial body 202. This adjustability may be particularly suitable where the solar panel system 100 is, for example, upgraded to hold a differently sized solar panel 102 or other structure, which would affect the resonant frequency of the solar panel system 100 and hence demand a change in the device 200 to account for the changed resonant frequency. In some embodiments, a mass of the inertial body 202 is selected based on the mass distribution of the solar panel system 100 and the degree of damping desired. In some embodiments, the biasing mechanism 210 is selected or configured to match or nearly match the natural frequency of the torsional mode to be damped.

In some adjustable embodiments, device 200 is configured such that an operator may remove and replace a first viscous fluid 208 with a first viscosity with a second viscous fluid 208 with a second viscosity that is different from the first viscosity.

Those skilled in the art will understand that, although a viscous fluid 208 is primarily described in this document, any damping element tending to bias the inertial body 202 towards a resting position may be implemented. For example, a brake, braking interface, viscous damping device, restraint, or other mechanical, electrical, or magnetic blocking or retarding device between the inertial body 202 and the housing 204 may be provided. In some embodiments, one or more ball bearings or a ball bearing interface may be placed between the inertial body 202 and the housing 204. In some embodiments, the ball bearings may be configured to provide a resistance force to damp rotation of the inertial body 202 via friction or any suitable manner of resistance.

Continuing with FIGS. 4-6, the device 200 generally has a first end 224 and a second end 228 with a longitudinal axis X extending therebetween and about which the inertial body 202 may rotate. In some embodiments, the first end 224 has a mounting interface 235 which may include a flange 234 (see also FIG. 9) and fastener engagement 226 (e.g. bolt attachment interface) to enable an operator to affix the device 200 to a shaft 104 of a solar panel system 100. The flange 234 and fastener engagement 226 may include a screw or bolt interface, or other affixing means suitable for affixing the device 200 to the shaft 104.

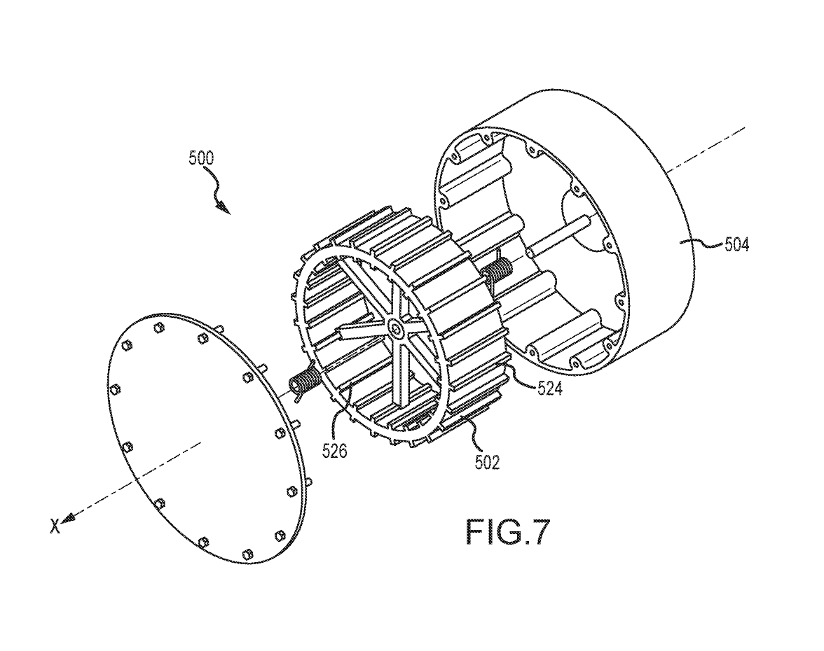

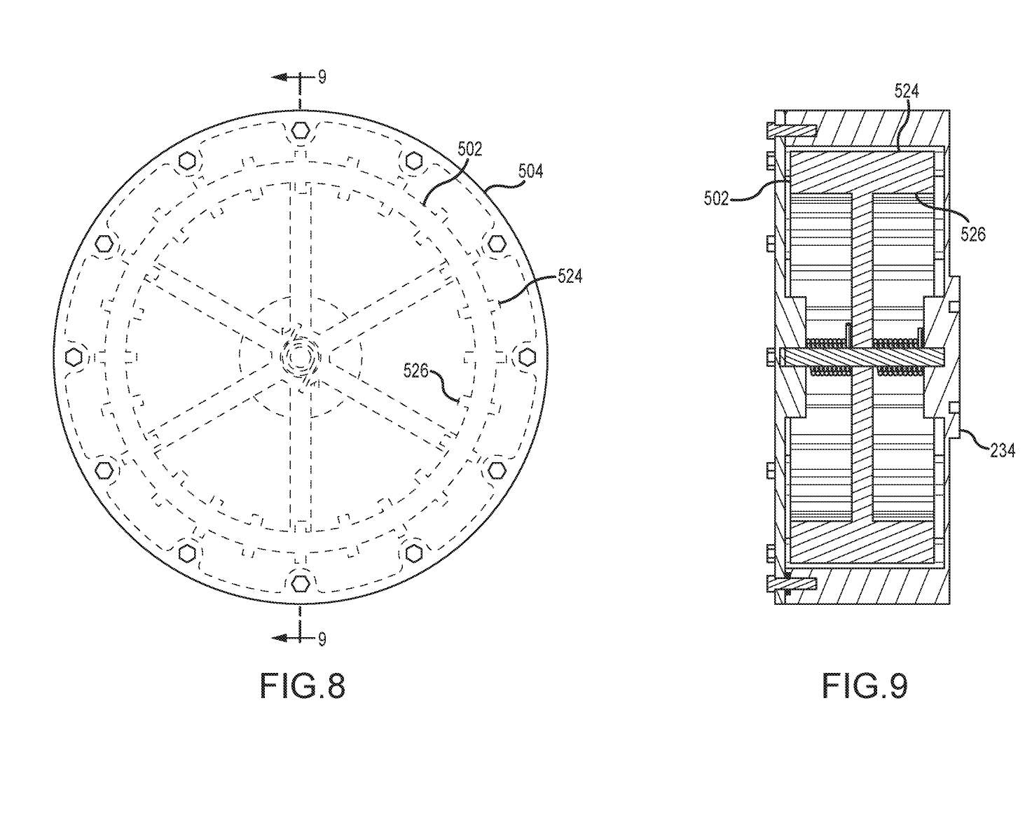

In some embodiments, and as illustrated in FIGS. 7-9, the device 500 may have an inertial body 502 that has one or more added drag elements 524, 526. For example, outer drag element(s) 524 may include ribs, dimples, ridges, recesses, or other features disposed on an exterior region of the inertial body 502 that tend to introduce an increased drag force between the inertial body 502 and the viscous fluid (not illustrated in FIG. 7) and/or the viscous fluid and the housing 504. Relatedly, inner drag element(s) 526 may include ribs, dimples, ridges, recesses, or other features that tend to introduce an increased drag force between the inertial body 502 and the viscous fluid and/or the viscous fluid and the housing 504. Providing added drag elements 524, 526 may enable an operator to use a less viscous fluid 208 and/or adjust the device 500 to a different level of damping or resistance suitable for the particular conditions of the field. The device 500 may have other features that are substantially similar or identical to those described in detail with reference to the device 200 illustrated in FIGS. 4-6. In some embodiments, the drag force may make up a component of a resistance force between the inertial body 202 and a damping element such as the viscous fluid 208.

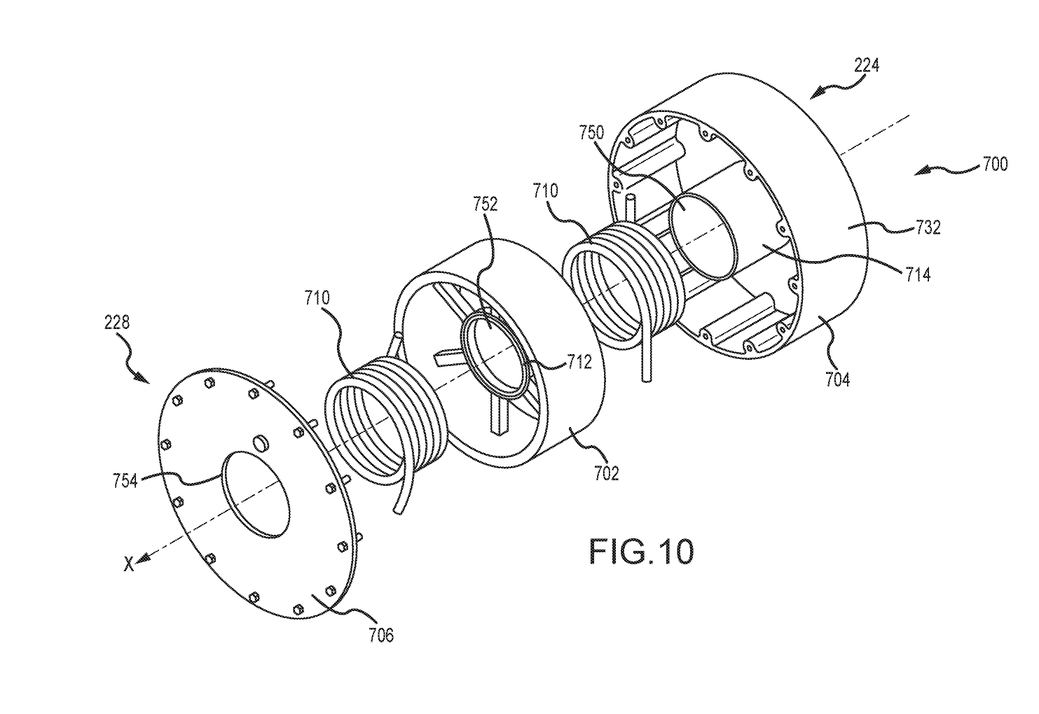

Turning now to FIG. 10, in some embodiments, the device 700 may be configured to slide on to a shaft 104. For example, the housing 704 (which may include the main body 732, axle 714, and cover 706), the inertial body 702 (which may include the bearing 712), and the biasing mechanism 710 may each have a passage 750 therethrough, with the passage 750 being suitable to fit about a shaft 104 in a solar panel system 100. Those skilled in the art will understand that the passage 750 and/or the shaft 104 may have a round, polygonal, or other cross-section profile.

In some embodiments, the passage 750 need not extend through the entirety of the device 700. For example, the device 200, 700 may include a recess (not illustrated) that only extends into a portion of the first end 224 or second end 228 of the device 200, 700 such as, for example through a portion of the housing 704, to facilitate attachment to the shaft 104. The recess may include other means for assisting in affixing the device 200, 700 to the shaft 104, such as, for example, cams, hinges, locks, screws, etc.

The embodiments described in the preceding two paragraphs may facilitate the ease of assembling or affixing the device 200, 700 to an end 110 of a shaft 104 that is already installed in the field without dismantling the solar panel system 100.

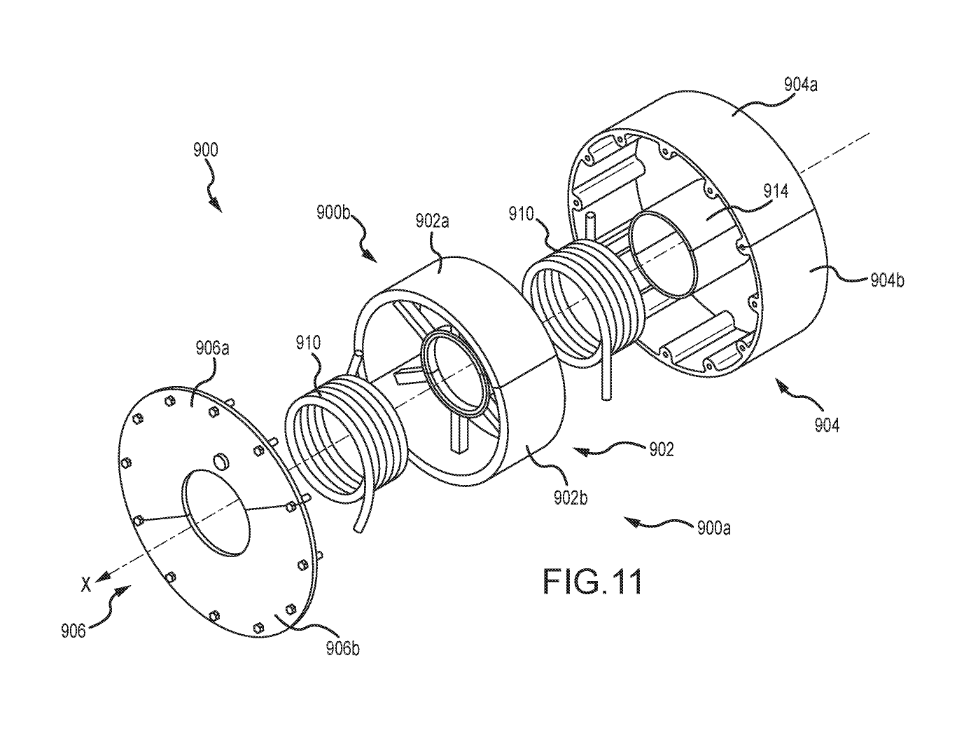

Turning now to FIG. 11, in some embodiments, the device 900 is configured to allow an operator to attach the device 900 to a central portion of the shaft 104, such as between panels 102 that are already assembled, instead of on the ends of the shaft. As illustrated, the device 900 may have a housing 904 with a first housing portion 904a and a second housing portion 904b that are configured to fit around the shaft 104 and couple to each other. In some embodiments, the device 900 includes a plurality of linear springs configured to apply a net biasing force in a manner similar that described in reference to biasing mechanism 210. Moreover, those skilled in the art will envision numerous means for coupling the first housing portion 904a and the second housing portion 904b together, and that a sealing element such as a gasket or other seal may be provided to prevent leakage of the viscous fluid 208 from the device 900.

Likewise, the inertial body 902 may have a first inertial body portion 902a and a second inertial body portion 902b; the cover 906, where provided, may also have a first cover portion 906a and a second cover portion 906b. The biasing mechanism 910 may include a torsional spring that is wound about the shaft 104 in the field, or may include a plurality of torsional spring portions that are coupled together. Taken together, the device 900 may have a first portion 900a and a second portion 900b that fit about the shaft 104. If a viscous fluid 208 is used, the portions 900a, 900b should be provided with a seal to prevent leakage.

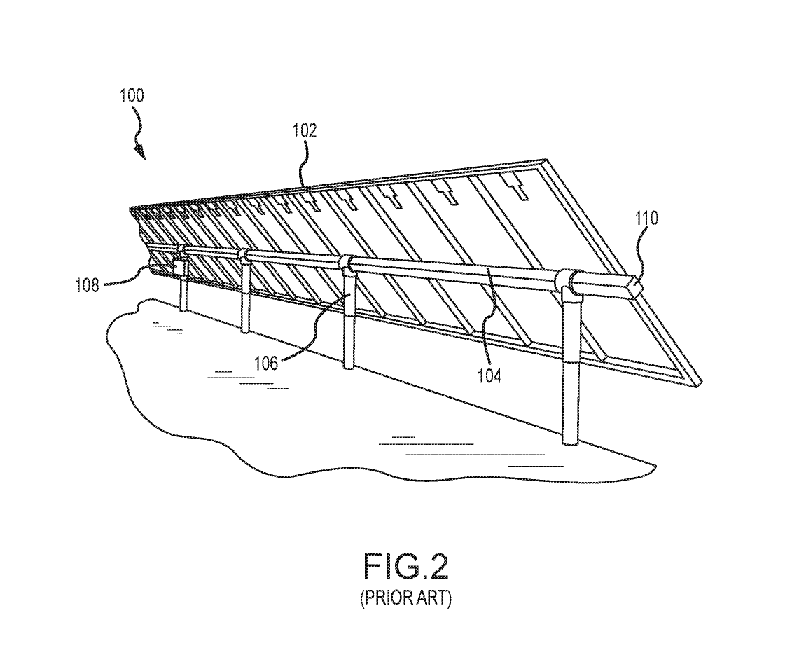

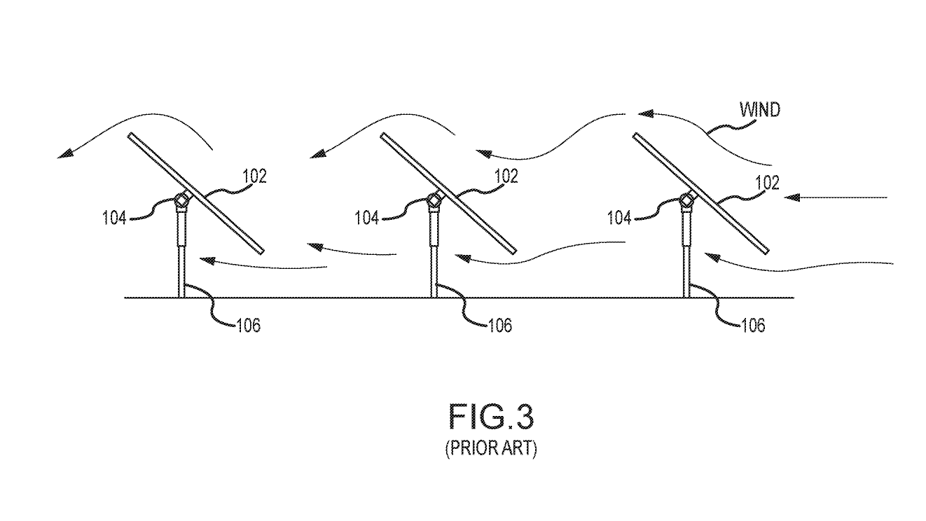

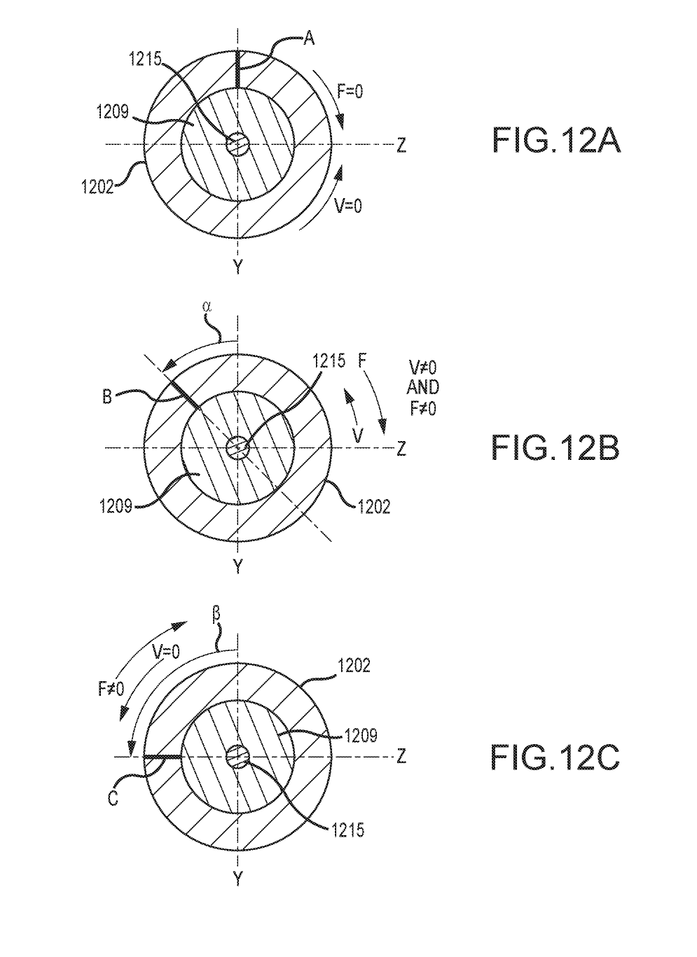

Turning now to FIGS. 12A-12C, some relational aspects between the inertial body 1202 and a mounting feature 1215 are now described. The inertial body 1202 depicted in FIGS. 12A-12C generally depicts the inertial body 202, 502, 702, 902 illustrated in FIGS. 4, 7, 10, and 11, respectively. The mounting feature 1215 may be an axle, such as the axle 214 in the housing 204 (see, e.g., FIG. 4), or the mounting feature 1215 may be a shaft, such as the shaft 104 in the solar panel system 100 (see e.g. FIG. 2). The mounting feature 1215 may have a circular profile as illustrated, although those skilled in the art will understand that other profiles are contemplated, such as a square, hexagonal, or any other polygonal and/or curved shape suitable for the purpose of mounting a torsional damping device 200, and, in some embodiments, a solar panel 102 as well.

A damping element 1209 may be provided to effectuate a net rotational force F on the inertial body 1202. The damping element 1209 may be a combination of a viscous fluid 208 and a spring or biasing element or mechanism, such as the spring 210 illustrated in FIG. 4 or biasing element or mechanism 710, 910, 110 illustrated in FIGS. 10, 11, and 13, respectively, for example, or the damping element 1209 may be a combination of a brake and a spring, or any other suitable combination of friction and bias elements. The damping element 1209 generally depicts the damping element 209 as it is most clearly illustrated in FIG. 6; other figures do not depict the viscous fluid 208, although, again, the damping element 1209, 209 may be a combination of a viscous fluid 208 and a spring or biasing element or mechanism 210, 710, 910, 110 as illustrated in FIGS. 4, 10, 11, and 13, respectively. The damping element 1209 may be configured to apply both a) a biasing force to bias the inertial body 1202 towards a neutral position A and b) a resistance force tending to bring the inertial body 1202 towards a fixed position (that is, wherein the inertial body 1202 is not rotating relative to the mounting feature 1215). The resistance force may be achieved using a brake, viscous fluid 208, or other suitable frictional element that tends to cause the inertial body 1202 to stop rotating (regardless of which direction the inertial body is in, in some embodiments), and the biasing force may be achieved using a pair of torsional springs 210 that tend to bring the inertial body towards the neutral position A regardless of how fast and in which direction the inertial body 1202 is moving or rotating.

As illustrated in FIG. 12A, the torsional damping device 200 may have an inertial body 1202 with a neutral position A. The neutral position A is achieved when the inertial body 1202 is rotated to a position wherein the inertial body 1202 is not in motion, that is, the velocity V is 0, and the inertial body 1202 is not experiencing a net force by the damping element 1209. The net rotational force F experienced by the inertial body 1202 at the neutral position A is 0, when, for example, a solar panel assembly 100 to which the device 200 is attached is not moving or oscillating in the wind.

Turning now to FIG. 12B, when the torsional damping device 200 is mounted to a solar panel assembly 100 that is in motion or “galloping” due to wind, the device 200 will move with the solar panel assembly 100. As the device 200 moves with the solar panel assembly 100, the inertial body 1202 is configured to rotate relative to the mounting feature 1215. As illustrated in FIG. 12B, when the inertial body 1202 rotates relative to the mounting feature 1215, such as by a first angle a that is not zero relative to the neutral position A and at a velocity that is not 0 relative to the mounting feature 1215, the damping element 1209 is configured to apply both a biasing force and a resistance force on the inertial body 1202. That is, when the inertial body 1202 is rotated or moved to a second position B and is in motion relative to the mounting element 1215, the damping element 1209 is configured to tend to both slow the inertial body 1202 and return the inertial body 1202 to the neutral position A. Again, the device 200 will generally have an inertial body 1202 that is in motion and/or rotated to a second position B when the solar panel assembly 100 to which the device 200 is attached is in motion.

Turning now to FIG. 12C, when the inertial body 1202 reaches a second position C and is not in motion relative to the mounting feature 1215, such as when the inertial body 1202 is rotated an angle 13 from the neutral position A, the damping element 1209 may be configured to apply a biasing force and a resistance force to the inertial body 1202 in a manner similar to that previously described. However, the resistance force component may be configured cause the inertial body 1202 to tend to come to a stopping position even as the inertial body 1202 is rotating towards the neutral position A. At the second position C, the biasing force may make up a greater component of the rotational force F than does the resistance force. The device 200 may have an inertial body 1202 at a second position C and not rotating relative to a mounting feature 1215 when or shortly after the solar panel assembly 100 has reached a maximum distance of oscillation in wind.

By combining resistance forces and biasing forces in this manner, the device 200 may be configured to effectuate a counter-rotational force on the solar panel assembly 100 or structure to which the device 200 is attached when the first inertial body 202, 1202 is in the second position B, C. Put succinctly, in some embodiments, the device 200 may be configured to damp motion of a solar panel system 100 experiencing winds tending to cause the system 100 to oscillate at a resonant frequency of the solar panel system 100. The device 200 may damp motion of the system 100 by changing the resonant frequency of the system 100 to one that does not respond to the particular winds being applied to the solar panel system 100, or by applying counter-rotational forces on the solar panel system 100, such as wherein the counter-rotational forces are intentionally not tuned to the resonant frequency of the system. In some embodiments, the device 200 is configured to excite the solar panel system 100 at a frequency that is different from the resonant frequency of the solar panel system 100.

In some embodiments, the device 200 is configured to effectuate a rotational force or torque that counters the rotational inertia of the system 100. For example, the countering rotational force may have a phase and may be configured to be 90 degrees out of phase with a phase of the primary structure, thereby reducing net forces on the primary structure. The greatest countering forces may occur when the rotational speed of the secondary mass, relative to the primary mass, is maximized Depending on the phase, this may occur when the primary mass reaches maximum deflection.

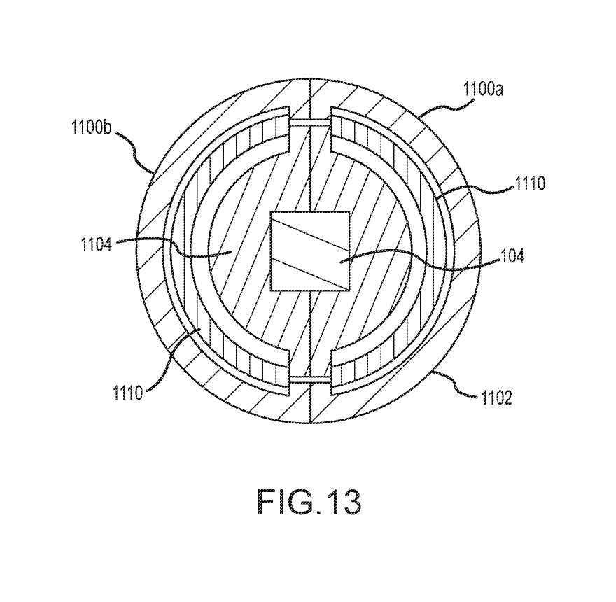

Turning now to FIG. 13, those skilled in the art will understand that a torsional spring is not the only option for a biasing mechanism 210, 1100. For example, a biasing mechanism 1100 may include one or more compression springs 1110, which may be particularly suited for embodiments intended for installation at the center of a shaft 104 after the solar panel system 100 is already installed. For example, the biasing mechanism 1100 may have a first portion 1100a and a second portion 1100b that are configured to fit about a shaft and couple together using any coupling means known in the art. The compression springs 1110 may be configured to interface with an inner portion of the inertial body 1102 and a clamp 1104 affixing the device to the shaft 104 to bias the device towards a neutral position, such as by way of abutting flanges or projections in the inertial body 1102 and/or the clamp 1104.

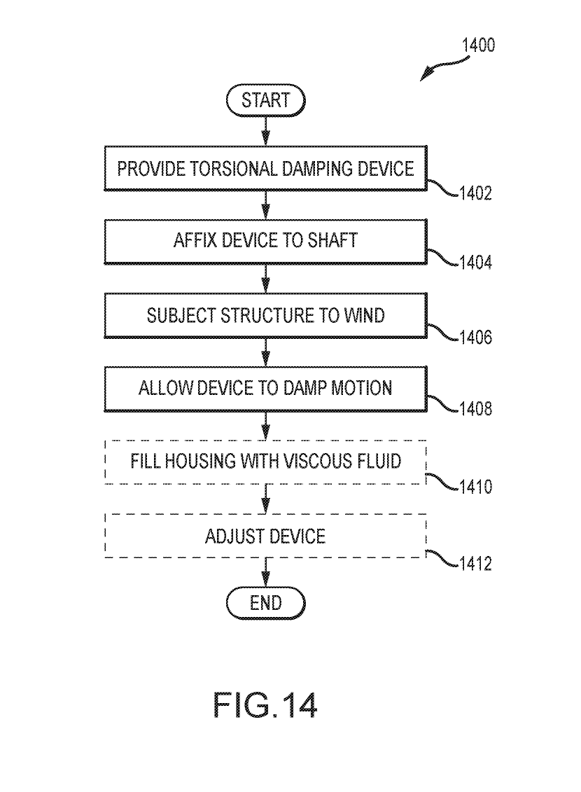

Turning now to FIG. 14, a method 1400 of damping wind effects on a structure such as a solar panel system is disclosed.

The method 1400 includes providing 1402 a torsional damping device, affixing 1404 the device to a shaft of the structure or solar panel system, subjecting 1406 the structure or solar panel system to wind tending to cause the solar panel system to oscillate, and allowing 1408 the device to damp motion of the structure or solar panel system, such as by allowing the first inertial body to rotate relative to the housing. In some embodiments, the method 1400 includes damping motion of a solar panel system experiencing winds tending to cause the system to oscillate at a resonant frequency of the solar panel system.

The method 1400 may also include filling 1410 the housing with a first viscous fluid.

The method 1400 may also include selecting a first inertial body to be configured to damp motion of the solar panel system at the resonant frequency and/or replacing a first inertial body with a second inertial body having a moment of inertia that is different from the moment of inertia of the first inertial body.

The method 1400 may also include adjusting 1412 the torsional damping device. Adjusting 1412 may include at least one of (a) replacing a first inertial body with a second inertial body having a moment of inertia that is different from the moment of inertial of the first inertial body and (b) replacing a first viscous fluid with a second viscous fluid, the second viscous fluid having a viscosity that is different from a viscosity of the first viscous fluid.

The method 1400 may also include sliding the torsional damping device onto a shaft in the solar panel system, clamping the torsional damping device onto a shaft in the solar panel system, and/or fastening the torsional damping device onto an end of a shaft in the solar panel system.

The method 1400 may also include accessing an interior region of the housing after affixing the torsional damping device to the mounting shaft.

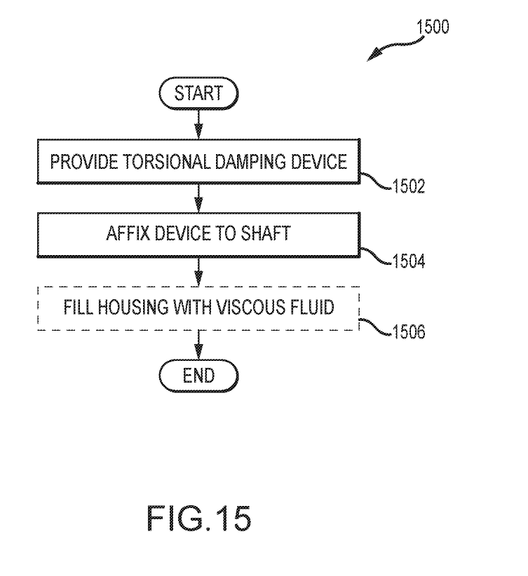

With reference now to FIG. 15, a method 1500 of retrofitting a solar panel system is also disclosed herein. The method 1500 includes providing 1502 a torsional damping device, affixing 1504 the device to a shaft of the structure or solar panel system.

In some embodiments, the method 1400 may include measuring the motion of the solar panel using motion sensors, such as accelerometers, to determine natural frequencies and mode shapes. In some embodiments, the method 1400 includes calculating an expected natural frequency based on the design parameters of the solar panel system. In some embodiments, the method 1400 includes adjusting or tuning the device to match the natural frequency of interest.

The method 1500 may also include filling 1506 the housing with a first viscous fluid.

The method 1500 may also include selecting a first inertial body to be configured to damp motion of the solar panel system at the resonant frequency and/or replacing a first inertial body with a second inertial body having a moment of inertia that is different from the moment of inertia of the first inertial body.

The method 1500 may also include adjusting the torsional damping device. Adjusting may include at least one of (a) replacing a first inertial body with a second inertial body having a moment of inertia that is different from the moment of inertial of the first inertial body and (b) replacing a first viscous fluid with a second viscous fluid, the second viscous fluid having a viscosity that is different from a viscosity of the first viscous fluid.

The method 1500 may also include sliding the torsional damping device onto a shaft in the solar panel system, clamping the torsional damping device onto a shaft in the solar panel system, and/or fastening the torsional damping device onto an end of a shaft in the solar panel system.

The method 1500 may also include accessing an interior region of the housing after affixing the torsional damping device to the mounting shaft.

The method 1500 may have all steps described with reference to method 1400 and vice versa. Likewise, either method 1400, 1500 may be achieved using the devices 200, 500, 700, 900, 1100 previously described herein.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

Each of the various elements disclosed herein may be achieved in a variety of manners. This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled.

As but one example, it should be understood that all action may be expressed as a means for taking that action or as an element which causes that action. Similarly, each physical element disclosed should be understood to encompass a disclosure of the action which that physical element facilitates. Regarding this last aspect, by way of example only, the disclosure of a “fastener” should be understood to encompass disclosure of the act of “fastening” —whether explicitly discussed or not—and, conversely, were there only disclosure of the act of “fastening”, such a disclosure should be understood to encompass disclosure of a “fastening mechanism”. Such changes and alternative terms are to be understood to be explicitly included in the description.

The previous description of the disclosed embodiments and examples is provided to enable any person skilled in the art to make or use the present invention as defined by the claims. Thus, the present invention is not intended to be limited to the examples disclosed herein. Various modifications to these embodiments will be readily apparent to those skilled in the art, and the generic principles defined herein may be applied to other embodiments without departing from the spirit or scope of the invention as claimed.

What is claimed is:

1. A torsional damping device, comprising
a first inertial body having a rotational axis and a moment of inertia relative to the rotational axis, the first inertial body rotatable about the rotational axis between a neutral position and a second position;
a housing configured to house the inertial body, the housing having a mounting surface for mounting to a structure experiencing a rotational force, the first inertial body rotatably and removably coupled to the housing;
a biasing mechanism configured to bias the first inertial body towards the neutral position;
a damping element configured to damp motion of the first inertial body relative to the housing; wherein
the neutral position of the first inertial body comprises a position wherein the first inertial body is not in motion relative to the housing and is not experiencing a net rotational force;
the second position of the first inertial body comprises a position wherein the first inertial body is experiencing a net rotational force from at least one of (a) the biasing mechanism and (b) the damping element; and
the first inertial body is configured to effectuate a counter-rotational force on the structure when the first inertial body is in the second position.

2. The torsional damping device of claim 1, wherein
the structure is a solar panel system having a resonant frequency; and
the torsional damping device is configured to damp motion of the structure at the resonant frequency.

3. The torsional damping device of claim 1, wherein
the first inertial body is removable from the housing; and
the housing is configured to house a second inertial body having a moment of inertia that is different from the moment of inertia of the first inertial body.

4. The torsional damping device of claim 1, further comprising:
the torsional damping device is configured to receive at least one of a replacement inertial body and a replacement damping element, whereby the torsional damping device is adjustable to damp motion of a structure having a resonant frequency.

5. The torsional damping device of claim 1, wherein
the biasing mechanism comprises a spring.

6. The torsional damping device of claim 1, wherein
the damping element comprises a viscous fluid.

7. The torsional damping device of claim 6, wherein the housing further comprises:
a port configured to enable an operator to at least one of (a) introduce the viscous fluid into the housing and (b) remove the viscous fluid from the housing.

8. The torsional damping device of claim 1, wherein
the damping element comprises a brake.

9. The torsional damping device of claim 1, wherein
the mounting structure comprises a passage through at least a portion of the housing and the first inertial body whereby the torsional damping device is mountable on a shaft.

10. The torsional damping device of claim 9, wherein
the housing comprises a first housing portion and a second housing portion, the first housing portion detachably coupled to the second housing portion, the housing configured to fit around the shaft; and
the first inertial body comprises a first body portion and a second body portion, the first body portion detachably coupled to the second body portion, the first inertial body configured to fit around the shaft.

11. The torsional damping device of claim 1, wherein
the housing comprises a longitudinal axle; and
the first inertial body comprises a cylindrical outer circumference and a bearing for mounting to the axle.

12. The torsional damping device of claim 1, wherein
the mounting surface comprises a flange for attaching the torsional damping device to an end of a shaft.

13. The torsional damping device of claim 1, wherein the housing further comprises:
a detachable cover configured to enable an operator to access an interior region of the housing without damaging the torsional damping device.

14. A method of damping wind effects on a solar panel system, the method comprising:
providing a torsional damping device, the torsional damping device having:
a first inertial body having a rotational axis and a moment of inertia relative to the rotational axis, the first inertial body rotatable about the rotational axis between a neutral position and a second position;
a housing configured to house the inertial body, the housing having a removable cover and a mounting surface for mounting to a structure experiencing a rotational force, the first inertial body rotatably and removably coupled to the housing;
a biasing mechanism configured to bias the first inertial body towards the neutral position;
a first damping element configured to damp motion of the first inertial body relative to the housing; wherein
the neutral position of the first inertial body comprises a position wherein the first inertial body is not in motion relative to the housing and is not experiencing a net rotational force;
the second position of the first inertial body comprises a position wherein the first inertial body is experiencing a net rotational force from at least one of (a) the biasing mechanism and (b) the first damping element; and
the first inertial body is configured to effectuate a counter-rotational force on the structure when the first inertial body is in the second position;
affixing the torsional damping device to a mounting shaft of the solar panel system;
subjecting the solar panel system to wind tending to cause the solar panel system to oscillate; and
allowing the first inertial body to rotate relative to the housing.

15. The method of claim 14, further comprising:
introducing the first damping element to the housing by filling the housing with a first viscous fluid.

16. The method of claim 14, wherein:
the solar panel system has a resonant frequency; and
the method comprises damping motion of the solar panel system at the resonant frequency.

17. The method of claim 16, further comprising:
selecting the first inertial body to be configured to damp motion of the solar panel system at the resonant frequency.

18. The method of claim 14, further comprising:
replacing the first inertial body with a second inertial body having a moment of inertia that is different from the moment of inertia of the first inertial body.

19. The method of claim 14, further comprising:
adjusting the torsional damping device to damp motion of the solar panel system having a first resonant frequency or a second resonant frequency different from the first resonant frequency; wherein
adjusting comprises at least one of (a) replacing the first inertial body with a second inertial body having a moment of inertia that is different from the moment of inertial of the first inertial body and (b) replacing the first damping element with a second damping element, the second damping element having a coefficient of resistance that is different from a coefficient of resistance of the first damping element.

20. The method of claim 19, further comprising providing a torsional damping device comprising a first viscous fluid; and wherein
adjusting comprises replacing the first viscous fluid with a second viscous fluid having a viscosity that is different from a viscosity of the first viscous fluid.

21. The method of claim 14, further comprising:
sliding the torsional damping device onto a shaft in the solar panel system;
clamping the torsional damping device onto a shaft in the solar panel system; or
fastening the torsional damping device onto an end of a shaft in the solar panel system.

22. The method of claim 14, further comprising:
accessing an interior region of the housing after affixing the torsional damping device to the mounting shaft.

23. A method of retrofitting a solar panel system, the method comprising:
providing a torsional damping device, the torsional damping device having:
a first inertial body having a rotational axis and a moment of inertia relative to the rotational axis, the first inertial body rotatable about the rotational axis between a neutral position and a second position;
a housing configured to house the inertial body, the housing having a mounting surface for mounting to a structure experiencing a rotational force, the first inertial body rotatably and removably coupled to the housing;
a biasing mechanism configured to bias the first inertial body towards the neutral position;
a damping element configured to damp motion of the first inertial body relative to the housing; wherein
the neutral position of the first inertial body comprises a position wherein the first inertial body is not in motion relative to the housing and is not experiencing a net rotational force;
the second position of the first inertial body comprises a position wherein the first inertial body is experiencing a net rotational force from at least one of (a) the biasing mechanism and (b) the damping element; and
the first inertial body is configured to effectuate a counter-rotational force on the structure when the first inertial body is in the second position; and
affixing the torsional damping device to a mounting shaft of the solar panel system.

24. The method of claim 23, wherein:
the solar panel system has a resonant frequency; and
the method comprises selecting the first inertial body to be configured to damp motion of the solar panel system at the resonant frequency.

25. The method of claim 23, further comprising:
replacing the first inertial body with a second inertial body having a moment of inertia that is different from the moment of inertia of the first inertial body.

26. The method of claim 23, further comprising:
adjusting the torsional damping device to damp motion of the solar panel system having a first resonant frequency or a second resonant frequency different from the first resonant frequency; wherein
adjusting comprises at least one of (a) replacing the first inertial body with a second inertial body having a moment of inertia that is different from the moment of inertial of the first inertial body and (b) replacing a first viscous fluid with a second viscous fluid, the second viscous fluid having a viscosity that is different from a viscosity of the first viscous fluid.

27. The method of claim 23, further comprising:
sliding the torsional damping device onto a shaft in the solar panel system;
clamping the torsional damping device onto a shaft in the solar panel system; or
fastening the torsional damping device onto an end of a shaft in the solar panel system.
